(19) United States
(12) Patent Application Publication
(10) Pub. No.: US 2018/0349030 A1
(43) Pub. Date: Dec. 6, 2018

(54) STORAGE CONTROL DEVICE, STORAGE CONTROL PROGRAM, AND STORAGE SYSTEM

(71) Applicant: FUJITSU LIMITED, Kawasaki-shi (JP)

(72) Inventors: Takahiro Ohyama, Kawasaki (JP); Noriyuki Yasu, Kawasaki (JP); TATSUHIKO MACHIDA, Kawasaki (JP); Kenichiro Shibata, Kawasaki (JP)

(73) Assignee: FUJITSU LIMITED, Kawasaki-shi (JP)

(21) Appl. No.: 15/990,968

(22) Filed: May 29, 2018

(30) Foreign Application Priority Data
May 31, 2017 (JP) 2017-108743

(51) Int. Cl. G06F 3/06

(52) U.S. Cl. CPC G06F 3/0604; G06F 3/0611; G06F 3/0689; G06F 3/064; G06F 3/0619; G06F 3/0659

(57) ABSTRACT

A storage control program for causing a storage control device to perform: receiving, from a higher-level device, an input/output request including a logical address specifying a logical block within a volume; and determining a storage control device for processing the input/output request from among a plurality of storage control devices that may access a storage having a physical storage area assigned to the volume based on the logical address included in the received input/output request, the number of logical blocks per divided block size partitioning the volume, and number of the plurality of storage control devices.

### CROSS-REFERENCE TO RELATED APPLICATION

This application is based upon and claims the benefit of priority of the prior Japanese Patent Application No. 2017-108743, filed on May 31, 2017, the entire contents of which are incorporated herein by reference.

### FIELD

The present disclosure related to a storage control device, a storage control program, and a storage system.

### BACKGROUND

In recent years, business conditions surrounding customers are changing from moment to moment, and a storage system is desired which may be expanded flexibly and promptly in response to a start of a new business or service or a change in work load of an existing service. As a method of expanding the storage system, there is scale-out. Scale-out may improve processing power by adding nodes.

There is an access control device that stores management information associating assignment information associated with an assigned real storage area with information identifying the block size of a logical block at a time of generating a logical volume. When a data access request is input, the access control device converts the data access request into a description based on the block length of a slice based on a logical block data length set in the management information corresponding to an access destination specified by the data access request (International Publication Pamphlet No. WO 2008/136097).

In addition, there is a technology that calculates an evaluation value indicating desirability as a usage object for each storage arranged in a distributed manner based on a bandwidth, a communication cost, and a physical distance between a node requesting writing and the storage, and selects a storage set based on the evaluation value (Japanese Laid-open Patent Publication No. 2004-126716).

### SUMMARY

In one aspect, a storage control program causes a storage control device to perform: receiving, from a higher-level device, an input/output request including a logical address specifying a logical block within a volume; and determining a storage control device for processing the input/output request from among a plurality of storage control devices that may access a storage having a physical storage area assigned to the volume based on the logical address included in the received input/output request, the number of logical blocks per divided block size partitioning the volume, and number of the plurality of storage control devices.

According to one aspect of the present disclosure, a storage control device for processing an I/O request from a higher-level device may be determined efficiently.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram of a system configuration of a storage system according to an embodiment;

FIG. 2 is a diagram of another system configuration of a storage system according to another embodiment;

FIG. 3 is a block diagram illustrating an example of a hardware configuration of a node;

FIG. 4 is a diagram of assistance in explaining an example of a format of logical-physical meta;

FIG. 5 is a block diagram illustrating an example of a functional configuration of a node;

FIG. 6 is a diagram of assistance in explaining an example of arrangement of in-charge nodes in each volume;

FIG. 7 is a diagram of assistance in explaining an example in which an I/O range extends over a plurality of divided blocks;

FIG. 8 is a sequence diagram illustrating an example of operation of a storage system;

FIG. 9 is a flowchart (1) illustrating an example of a storage control processing procedure of a node; and

FIG. 10 is a flowchart (2) illustrating an example of a storage control processing procedure of a node.

### DESCRIPTION OF EMBODIMENT

Embodiment of a storage control device, a storage control program, and a storage system according to the present disclosure will hereinafter be described in detail with reference to the drawings.

### EMBODIMENT

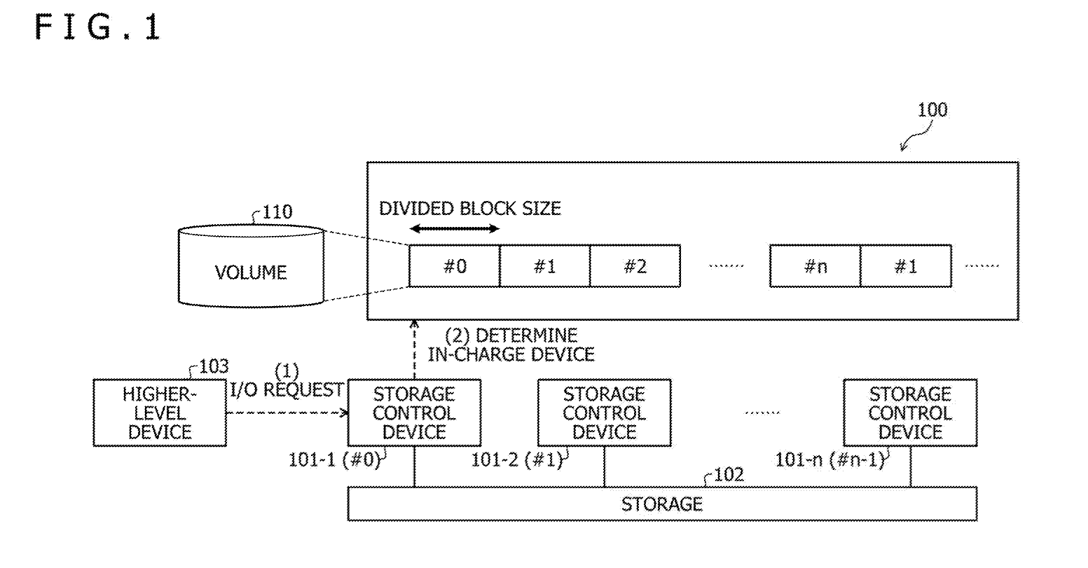

FIG. 1 is a diagram of assistance in explaining an embodiment of a storage system 100 including a storage control device 101 according to an embodiment. In FIG. 1, storage control devices 101-1 to 101-n (n is a natural number of two or more) are computers capable of accessing a storage 102. In the following description, an arbitrary storage control device of the storage control devices 101-1 to 101-n may be described as a “storage control device 101.”

In addition, the storage 102 includes one or more storage devices that store data. The storage device is, for example, a flash memory, a hard disk, an optical disk, a magnetic tape, or the like. A higher-level device 103 is a computer that performs information processing. The higher-level device 103 is, for example, a business server that performs business processing.

The storage control device 101 is, for example, applied to a virtualized storage device of a redundant array of inexpensive disks (RAID) configuration. The virtualized storage device is a storage device to which thin provisioning (Thin Provisioning) is applied.

Thin provisioning is a technology for reducing the physical capacity of a storage by virtualizing and allocating storage resources. In an environment in which thin provisioning is introduced, a capacity corresponding to a request of a user is not directly assigned to a physical disk or the like, but is assigned as a “logical volume (virtual volume).” Physical disks and the like are managed as a shared disk pool, and a capacity is assigned to the physical disks and the like according to an amount of data written to a logical volume.

In the following, a case is assumed in which a volume for each business is provided to a server in a virtualized storage device. In this case, as a method of performing load distribution of an I/O request from a server between a plurality of storage control devices (for example, the storage control devices 101-1 to 101-n), there is, for example, a method of determining a storage control device for processing the I/O request from the server for each volume.

However, with this method, when a business load is increased in a particular storage control device beyond the capacity of the device, latency is greatly degraded. In addition, when the number of businesses and business volumes increases beyond the device number of storage control devices, it becomes difficult to make storage design as to which business is operated in which storage control device, and it may be difficult to deal with variations in the number of businesses or changes in work load.

Therefore, distributing and processing an I/O request from a server for each volume by a plurality of storage control devices may distribute a load and maintain stable performance. This method determines which storage control device is in charge of which area within a volume.

As a method of determining a storage control device in charge of each area within a volume, a table or the like, for example, may be prepared in advance which stores correspondence relation between areas within the volume and storage control devices in charge of the corresponding respective areas. However, this method refers to the table or the like each time an I/O request is received, and thus invites an increase in a processing time taken for I/O processing. Further, a storage area for retaining the table or the like is secured in each storage control device, and may therefore invite a shortage of a storage capacity.

Accordingly, in the present embodiment, description will be made of the storage control device 101 that may efficiently determine which of the storage control devices 101-1 to 101-n is in charge of which area within a logical volume. An example of processing of the storage control device 101 will be described in the following.

(1) The storage control device 101 receives an I/O request from the higher-level device 103. Here, the I/O request is a read request or a write request for a volume. The volume is a logical volume (virtual volume) provided to the higher-level device 103. The storage 102 has a physical storage area assigned to the volume.

The I/O request includes a logical address specifying a logical block within the volume. The logical block is a management unit area defined by a given capacity. The logical address is, for example, specified by a logical block address (LBA). One LBA, for example, corresponds to an area of 512 B (Bytes) (one logical block).

The example of FIG. 1 assumes a case where the storage control device 101-1 receives an I/O request including the LBA of a volume 110 from the higher-level device 103.

(2) The storage control device 101 determines a storage control device 101 for processing the received I/O request from the storage control devices 101-1 to 101-n. Here, processing the I/O request refers to identifying the physical position of data from metadata specifying correspondence relation between a logical address and a physical address of the I/O requested data, and accessing the data.

In the following description, the storage control device 101 for processing the I/O request from the higher-level device 103 may be described as an “in-charge device.”

For example, the storage control device 101 determines the in-charge device based on the logical address included in the I/O request, the number of logical blocks per divided block size, and the device number n of the storage control devices 101-1 to 101-n. Here, the divided block size is the size of divided blocks divided by partitioning a volume.

The divided block size may be set arbitrarily, and is set to a value such that the I/O request is distributed to the storage control devices 101-1 to 101-n as much as possible. For example, an I/O size issued from the higher-level device 103 is divided into a size (for example, 8 MB) returned in an INQUIRY command at a maximum. Therefore, the divided block size may be set at 8 MB.

In addition, supposing that a logical address is specified by an LBA, the number of logical blocks per divided block size corresponds to the number of LBAs per divided block. As an example, the divided block size is set at “8 MB,” and one LBA is set at “512 B.” In this case, the number of logical blocks per divided block size is “8 MB/512 B.”

For example, the storage control device 101 may determine the in-charge device by using the following Equation (1). The following Equation (1) is an example of a mathematical expression that derives a device number identifying the in-charge device from the LBA of the volume, the LBA being included in the I/O request, the number of LBAs per divided block size, and the device number n of the plurality of storage control devices 101.

In the equation, “/” denotes an operator for obtaining a quotient. “% n” denotes an operator for obtaining a remainder resulting from division by n. “lba” is the LBA of the volume, the LBA being included in the I/O request, and is, for example, a head LBA specified as a logical address. “unit_size” is the number of LBAs per divided block size. “in-charge device number” is the device number of the in-charge device. “device number” is an identifier identifying each of the storage control devices 101-1 to 101-n managed internally in the storage control device 101, and is an integer that increments in order by one from zero. The device number that increments in order by one from zero is assigned to each of the storage control devices 101-1 to 101-n. In FIG. 1, “i” in “#i” denotes the device number (i=0, 1, . . . , n−1).

In-Charge Device Number=(lba/unit_size)% n (1)

As an example, lba is set at “50,” unit_size is set at “30,” and n is set at “4.” In this case, the in-charge device number is “1 (=(50/30)%4).” Therefore, the storage control device 101-1 determines that a storage control device 101 having an in-charge device number “1,” for example, the storage control device 101-2 is the in-charge device.

Thus, the storage control device 101 may efficiently determine the in-charge device from the storage control devices 101-1 to 101-n according to the logical address included in the I/O request from the higher-level device 103. Thus, a load imposed in I/O processing may be distributed among the storage control devices 101-1 to 101-n.

For example, the storage control device 101 may obtain the in-charge device number from the LBA of the volume 110 by using the above Equation (1). It is therefore possible to reduce a processing time taken for I/O processing, and reduce an amount of usage of a storage capacity, as compared with the case of using the table or the like indicating the correspondence relation between areas within the volume 110 and the in-charge devices in charge of the areas, for example.

(Example of System Configuration of Storage System 200)

Description will next be made of a case where the storage control device 101 illustrated in FIG. 1 is applied to a storage system 200. The storage system 200 is, for example, a redundant system of RAID 5 or 6 or the like. In the following description, the storage control device 101 may be described as a “node N.”

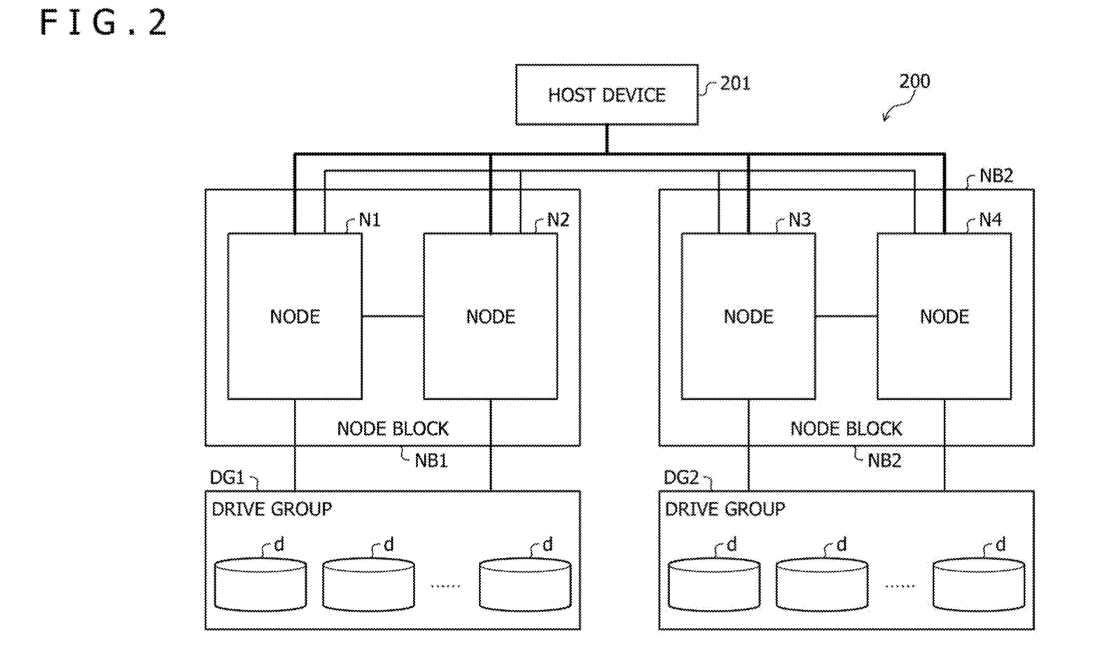

FIG. 2 is a diagram of assistance in explaining an example of a system configuration of the storage system 200. In FIG. 2, the storage system 200 includes node blocks NB1 and NB2 and drive groups DG1 and DG2. The node block NB1 includes a node N1 and a node N2. The node block NB2 includes a node N3 and a node N4.

The drive groups DG1 and DG2 are a set of drives d, and have 6 to 24 drives d, for example. The drives d are solid state drives (SSDs). However, hard disk drives (HDDs) may be used as the drives d. The storage 102 illustrated in FIG. 1 corresponds to the drive groups DG1 and DG2, for example.

Each of the nodes N1 and N2 within the node block NB1 may directly access each of the drives d of the drive group DG1 under own control. In addition, each of the nodes N3 and N4 within the node block NB2 may directly access each of the drives d of the drive group DG2 under own control. Each of the nodes N1 to N4 has configuration information and metadata.

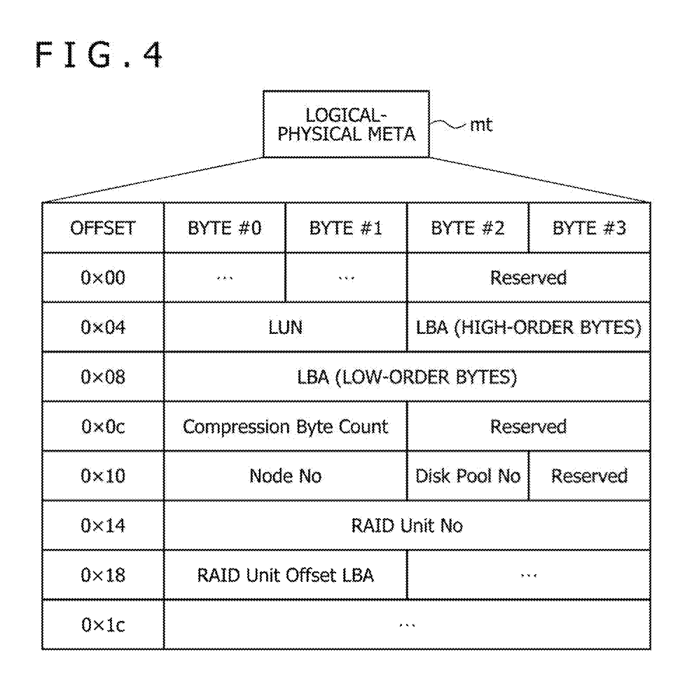

The configuration information, for example, includes logical volumes generated in the storage system 200 and various management information related to the drives d constituting a RAID. In addition, each of the nodes N1 to N4 manages data (user data) using the metadata. The metadata includes logical-physical meta mt managing correspondence relation between a logical address and a physical address of data. An example of a format of the logical-physical meta mt will be described later with reference to FIG. 4.

A host device 201 is a computer that requests reading/writing of data from and to a logical volume (virtual volume) provided by the storage system 200. The host device 201 is, for example, a business server using the storage system 200, a management server managing the storage system 200, or the like. The higher-level device 103 illustrated in FIG. 1 corresponds to the host device 201, for example. The storage system 200 is of an Active/Active configuration. Any of the nodes N1 to N4 may receive an I/O request from the host device 201.

In the storage system 200, each of the nodes N1 to N4 and the host device 201 are coupled to each other by fibre channel (FC) or internet small computer system interface (iSCSI), for example. For example, each of the nodes N1 to N4 is mutually communicatably coupled to the host device 201 via an expansion card for host (EC-H). In addition, nodes N within a node block NB are coupled to each other by internal communication. In addition, nodes N straddling node blocks NB are mutually communicatably coupled to each other via an expansion card for scale-out (EC-SO), for example.

In addition, the storage system 200 manages data in RAID units, for example. Physical allocation of thin provisioning is performed in chunk units of a fixed size. One chunk corresponds to one RAID unit. In the following description, chunks will be referred to as RAID units. A RAID unit is, for example, a continuous physical area of 24 MB assigned from a drive group DG. A RAID unit includes a plurality of user data units (referred to also as data logs). A user data unit, for example, includes management data of data written to a drive d and compressed data of the data written to the drive d.

Incidentally, while description has been made by taking as an example a case where the number of nodes included in the storage system 200 is four in the example of FIG. 2, the number of nodes may be equal to or more than five. In addition, while only one host device 201 is illustrated, the storage system 200 may be used by two or more host devices 201. In addition, the above description has been made by taking as an example a case where two nodes N are included in a node block NB for redundancy. However, there is no limitation to this. For example, the number of nodes N included in a node block NB may be one, and may be three or more. In addition, the storage system 200 allows nodes N to be added thereto in node block units, for example.

(Example of Hardware Configuration of Node N)

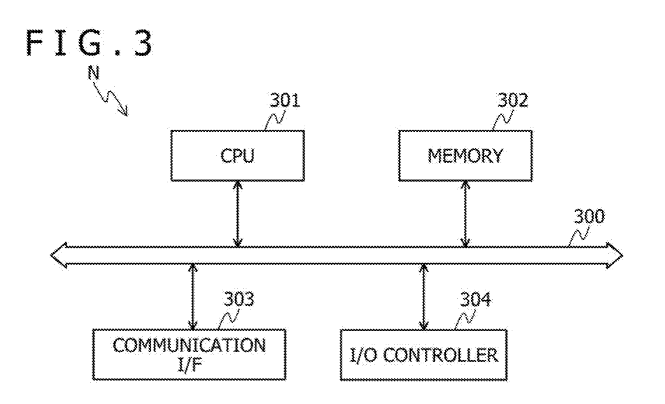

FIG. 3 is a block diagram illustrating an example of a hardware configuration of a node N. In FIG. 3, the node N includes a central processing unit (CPU) 301, a memory 302, a communication interface (I/F) 303, and an I/O controller 304. In addition, the constituent units are coupled to each other by a bus 300.

Here, the CPU 301 is in charge of controlling the whole of the node N. The memory 302, for example, includes a read only memory (ROM), a random access memory (RAM), a flash ROM, and the like. For example, the flash ROM and the ROM store various kinds of programs, and the RAM is used as a work area for the CPU 301. The programs stored in the memory 302 are loaded into the CPU 301, and thereby make the CPU 301 perform coded processing. The RAM, for example, includes a cache memory. The cache memory, for example, temporarily stores I/O data requested from the host device 201.

The communication I/F 303 is coupled to a network through a communication line, and is coupled to another computer (for example, the host device 201 or another node N illustrated in FIG. 2) via the network. The network is, for example, a local area network (LAN), a wide area network (WAN), the Internet, a storage area network (SAN), or the like. The communication I/F 303 is in charge of interfacing between the network and the interior of the device, and controls input or output of data from another computer. The communication I/F 303, for example, includes an EC-H, an EC-SO, and the like.

The I/O controller 304 accesses each of the drives d within the drive group DG under own control (see FIG. 2) under control of the CPU 301.

The I/O controller 304, for example, includes a peripheral component interconnect express (PCIe) switch.

(Example of Format of Logical-Physical Meta mt)

Description will next be made of an example of a format of logical-physical meta mt used by the node N. The logical-physical meta mt is, for example, stored in the memory 302 of the node N illustrated in FIG. 3.

FIG. 4 is a diagram of assistance in explaining an example of a format of the logical-physical meta mt. In FIG. 4, the logical-physical meta mt is information that may identify correspondence relation between a logical address and a physical address of data. The logical-physical meta mt is, for example, managed for each piece of data of 8 KB.

In the example of FIG. 4, the size of the logical-physical meta mt is 32 B. The logical-physical meta mt includes a logical unit number (LUN) of 2 B and an LBA of 6 B as a logical address of data. The logical-physical meta mt also includes a Compression Byte Count of 2 B as the number of bytes of compressed data. The logical-physical meta mt also includes a Node No of 2 B, a Disk Pool No of 1 B, a RAID Unit No of 4 B, and a RAID Unit Offset LBA of 2 B as a physical address.

The Node No is a number identifying a node N in charge of a drive group DG to which a RAID unit storing a data unit belongs. The Disk Pool No is a number identifying the drive group DG to which the RAID unit storing the data unit belongs. The RAID Unit No is a number identifying the RAID unit storing the data unit. The RAID Unit Offset LBA is the address of the data unit within the RAID unit.

(Example of Functional Configuration of Node N)

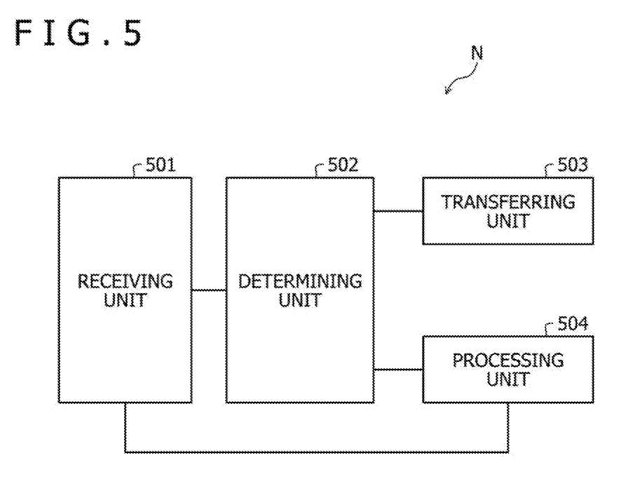

FIG. 5 is a block diagram illustrating an example of a functional configuration of the node N. In FIG. 5, the node N has a configuration including a receiving unit 501, a determining unit 502, a transferring unit 503, and a processing unit 504. The receiving unit 501 to the processing unit 504 function as a control unit. For example, the functions thereof are implemented by making the CPU 301 execute a program stored in the memory 302 illustrated in FIG. 3, or by the communication I/F 303 and the I/O controller 304. A processing result of each functional unit is stored in the memory 302, for example.

The receiving unit 501 receives an I/O request from the host device 201. Here, the I/O request is a read request or a write request for a volume V. The volume V is a logical volume (virtual volume) provided to the host device 201. Physical storage areas of drives d within the drive groups DG1 and DG2 illustrated in FIG. 2, for example, are assigned to the volume V as appropriate.

The I/O request includes a logical address specifying a logical block within the volume V. For example, the I/O request includes the LUN of the volume V and the LBA of the volume V. The LUN of the volume V is an identifier identifying the volume V used by the host device 201. The LBA of the volume V is an LBA as an access destination, and, for example, indicates a head LBA and an LBA range within the volume V. The LBA range indicates a range in which LBAs from the head LBA are accessed. The LBA range is, for example, indicated by the number of LBAs. The head LBA and the access range identify an I/O range (access range).

The determining unit 502 determines a node N for processing the I/O request received by the receiving unit 501 from the nodes N1 to N4. Here, the nodes N1 to N4 are a set of nodes N as constituent elements of the storage system 200. However, the storage system 200 may include five or more nodes N.

In the following description, the node N for processing the I/O request may be described as an “in-charge node N.”

For example, the determining unit 502 determines the in-charge node N based on the logical address included in the I/O request, the number of logical blocks per divided block size of the volume V, the volume number of the volume V, and the number of nodes of the storage system 200. The divided block size is the size of divided blocks divided by partitioning the volume V. The divided block size is, for example, 8 MB.

The volume number is an identifier identifying each volume V internally managed in the node N, and is an integer that increments in order by one from zero. The volume number may be identified from the configuration information with the LUN of the volume V as a key, for example. For example, the determining unit 502 refers to the configuration information, and identifies the volume number corresponding to the LUN of the volume V, the LUN being included in the I/O request.

The number of nodes of the storage system 200 is the number of the nodes N1 to N4 as constituent elements of the storage system 200. For example, the number of nodes is the number of nodes N constituting a pool in which the volume V is present. The pool is, for example, a RAID 6-based physical capacity pool constituted of a plurality of drives d.

Making description in more detail, the determining unit 502 may determine the in-charge node N by using the following Equations (2) and (3), for example. In the equations, node is a node number identifying the in-charge node N. The node number is an identifier for identifying each of the nodes N1 to N4 internally managed in the node N, and is an integer that increments in order by one from zero. For example, the node number corresponds to the “device number” described with reference to FIG. 1. “unit” indicates the number of an area (divided block) within the volume V to which area the LBA of the volume V corresponds, the LBA being included in the I/O request. “lba” indicates the LBA of the volume V, the LBA being included in the I/O request. “lba” is, for example, a head LBA as an access destination. “unit_size” is the number of LBAs per divided block size of the volume V. “lun” is the volume number of the volume V. “nodeCnt” indicates the number of nodes that are the nodes N1 to N4 as constituent elements of the storage system 200.

node=(unit+lun)% nodeCnt (2)

unit=lba/unit_size (3)

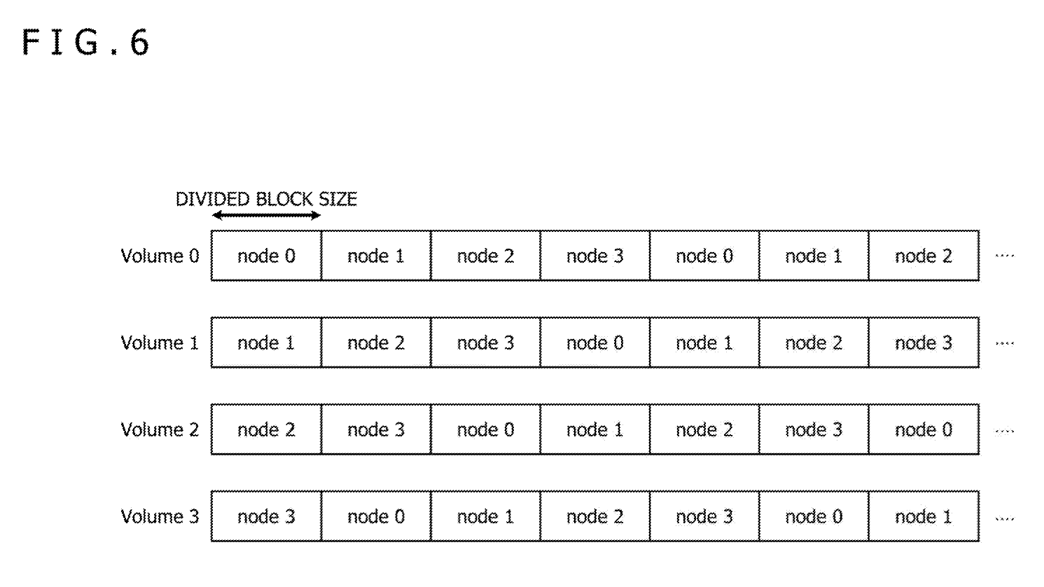

Incidentally, an example of arrangement of in-charge nodes N in each volume V, the in-charge nodes N being determined by using the above-described Equations (2) and (3), will be described later with reference to FIG. 6.

Here, the I/O range may extend over a plurality of divided blocks within the volume V. For example, an I/O size issued from the host device 201 is divided into a size (8 MB) returned in an INQUIRY command at a maximum. Hence, in a case where the divided block size is “8 MB,” the I/O range extends overs two divided block at a maximum.

Therefore, when the I/O range extends overs a plurality of divided blocks of the volume V, the determining unit 502 may divide the I/O range into a plurality of I/O ranges, and determine in-charge nodes N for I/O requests corresponding to the plurality of respective divided I/O ranges. For example, the determining unit 502 determines whether or not the I/O range extends over a plurality of divided blocks of the volume V based on the head LBA and the LBA range of the volume V, the head LBA and the LBA range being included in the I/O request, and the number of LBAs per divided block size.

Making description in more detail, the determining unit 502 calculates unit_cnt by using the following Equation (4), for example. “unit_cnt” indicates the number of divided blocks that the I/O range extends over. For example, unit_cnt indicates the number of in-charge nodes N for which the I/O request is divided. In the equation, start_lba is the head LBA of the volume V. “io_blk_cnt” is the number of LBAs indicated by the LBA range. “unit_size” is the number of LBAs per divided block size of the volume V.

unit_cnt={(start_lba+io_blk_cnt−1)/unit_size}−(start_lba/unit_size)+1 (4)

Then, when the calculated unit_cnt is “1,” the determining unit 502 determines that the I/O range does not extend over a plurality of divided blocks. On the other hand, when unit_cnt is “2,” the determining unit 502 determines that the I/O range extends over a plurality of divided blocks. Here, when the I/O range extends over a plurality of divided blocks, the determining unit 502 divides the I/O range into a plurality of I/O ranges, and determines in-charge node N for I/O requests corresponding to the plurality of respective divided I/O ranges.

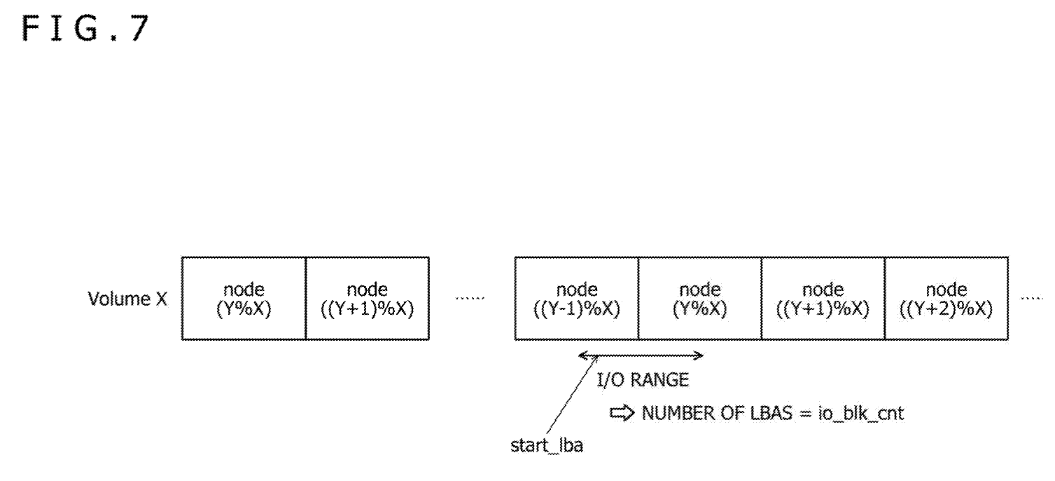

Incidentally, an example of determining the in-charge nodes N when the I/O range extends over a plurality of divided blocks of the volume V will be described later with reference to FIG. 7.

When the determined in-charge node N is another node, the transferring unit 503 transfers the I/O request to the in-charge node N. For example, the transferring unit 503 transfers the I/O request to the in-charge node N, and requests the in-charge node N to process the I/O request. As a result, the I/O request is processed in the in-charge node N. When the I/O request is a read request, for example, the transferring unit 503 receives data from the in-charge node N, and then transmits the received data to the host device 201.

When the determined in-charge node N is the own device, the processing unit 504 processes the I/O request. For example, the processing unit 504 refers to the logical-physical meta mt as illustrated in FIG. 4, and identifies the physical position (physical address) of the data based on the logical address (the LUN and the LBA) included in the I/O request.

Next, the processing unit 504 notifies the identified physical position to a physical in-charge node N. The physical in-charge node N is a node N that may directly access the data at the identified physical position. When the I/O request is a read request, for example, the processing unit 504 receives the data from the physical in-charge node N, and then transmits the received data to the host device 201. However, when the own device is the physical in-charge node N, the processing unit 504 reads the data.

In addition, when the receiving unit 501 receives an I/O request from another node, the processing unit 504 processes the I/O request, and notifies a processing result to the other node N. For example, when the other node determines that the node N is the in-charge node N, the node N receives, from the other node, the I/O request from the host device 201, and processes the I/O request as the in-charge node N.

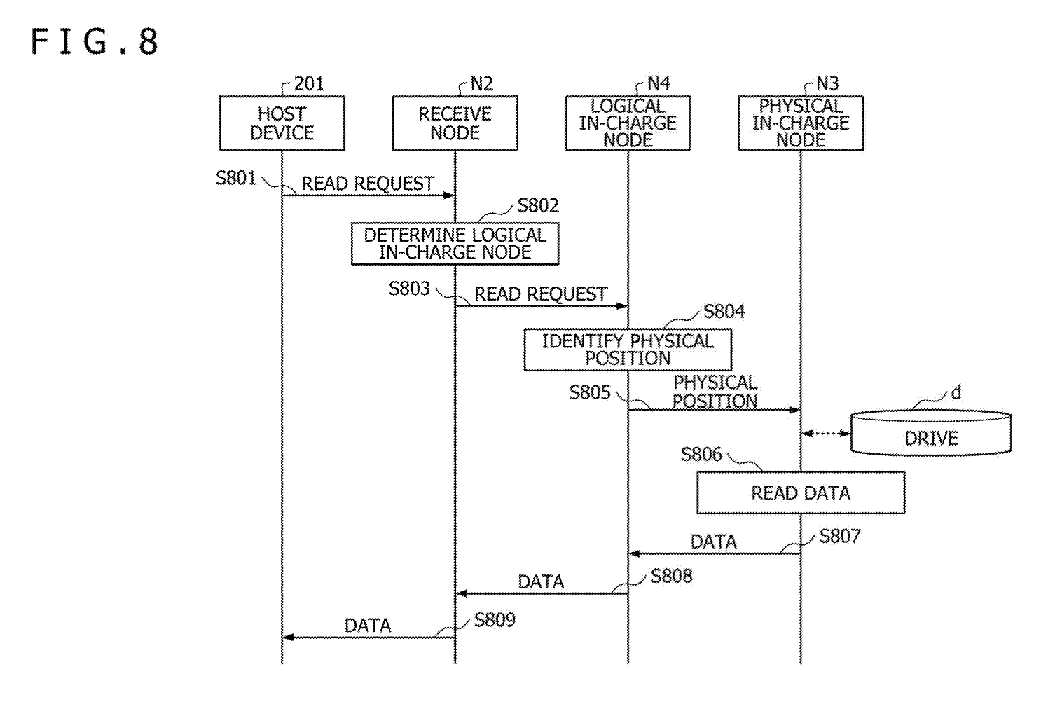

Incidentally, an example of operation of the storage system 200 for an I/O request from the host device 201 will be described later with reference to FIG. 8.

(Example of Arrangement of In-Charge Nodes N in Each Volume V)

Next, referring to FIG. 6, description will be made of an example of arrangement of in-charge nodes N in each volume V, the in-charge nodes N being determined by using the above-described Equations (2) and (3).

FIG. 6 is a diagram of assistance in explaining an example of arrangement of in-charge nodes N in each volume V. FIG. 6 illustrates in-charge nodes N for respective divided blocks in each volume V provided to the host device 201. Incidentally, in FIG. 6, “#” in node # denotes the node number of the node N. “#” in Volume # denotes the volume number of the volume V.

As illustrated in FIG. 6, within an identical volume V, the node numbers of the in-charge nodes N for respective divided block sizes differ from each other by one. It is thus possible to distribute a load imposed in I/O processing of each volume V among the nodes N1 to N4, and maintain stable performance of the storage system 200.

In addition, the node number of the in-charge node N of a head divided block differs between the volumes V. The load may therefore be distributed more in the whole of the storage system 200. For example, when there is access from an identical host device 201 or an identical operating system (OS) to a plurality of volumes V, patterns of access to the respective volumes V may be similar to each other. For example, access may concentrate on one divided block in each volume V. Even in such a case, because the in-charge node N at the beginning differs between the volumes V, a degradation in performance may be suppressed.

(Example of Determining In-Charge Nodes N when I/O Range Extends over a Plurality of Divided Blocks)

Next, referring to FIG. 7, description will be made of an example of determining in-charge nodes N when an I/O range extends over a plurality of divided blocks of a volume V.

FIG. 7 is a diagram of assistance in explaining an example in which an I/O range extends over a plurality of divided blocks. In FIG. 7, X denotes the volume number of the volume V. Y denotes the number of nodes. In the example of FIG. 7, the I/O range extends over a plurality of divided blocks, and therefore I/O processing is distributed to an in-charge node N having a node number “(Y−1)% X” and an in-charge node N having a node number “Y % X.” Here, suppose that one LBA is “512 B,” and that the divided block size is “8 MB.” In this case, unit_size is “0x4000 (=16384=8*1024*1024/512).”

An example of determining in-charge nodes N will be described in the following by taking as an example a case of receiving an I/O request (LBA: 0x7000 to 0x8FFF) for 4 MB from a position of 14 MB in a volume V having a volume number “2.”

First, the determining unit 502 calculates unit_cnt by using the above-described Equation (4). In this case, nodeCnt is “4.” In addition, start_lba is “0x7000.” In addition, io_blk_cnt is “0x2000 (=0x8FFF−0x7000+1).” Therefore, unit_cnt is “2 (=((0x7000+0x2000−1)/0x4000)−(0x7000/0x4000)+1=2−1+1).”

In this case, the determining unit 502 determines that the I/O range extends over two divided blocks. Then, the determining unit 502 divides the I/O range into two I/O ranges, and determines in-charge nodes N for I/O requests corresponding to the two respective divided I/O ranges. For example, the determining unit 502 first calculates lba_1, unit_1, node_1, and io_blk_cnt_1 for a first divided block.

“lba_1” is a head LBA as an access destination within the first divided block. “unit_1” indicates the number of an area within the volume V which area corresponds to the first divided block. “node_1” is the node number of the node N in charge of the first divided block. “io_blk_cnt_1” indicates the number of LBAs in an I/O range within the first divided block. A result of the calculation is as follows.

$${lba}_{—} 1 = {start}_{—} lba = 0 x 7000$$

$${unit}_{—} 1 = {lba}_{—} 1 \text{/} {unit}_{—} size = 0 x 7000 \text{/} 0 x 4000 = 1$$

$${node}_{—} 1 = ( {unit}_{—} 1 + lun ) \% nodeCnt = ( 1 + 2 ) \%4 = 3$$

$$\begin{matrix}{io}_{—} {blk}_{—} {cnt}_{—} 1 = ( {unit}_{—} 1 + 1 ) * {unit}_{—} size - {lba}_{—} 1 \\ = ( 1 + 1 ) * 0 x 4000 - 0 x 7000 \\ = 0 x 8000 - 0 x 7000 \\ = 0 x 1000\end{matrix}$$

Therefore, the I/O request for the first divided block is an I/O request to a node N having a node number “3,” the I/O request having, as an I/O range, a range of 0x1000 LBAs from an LBA “0x7000.”

Next, the determining unit 502 calculates lba_2, unit_2, node_2, and io_blk_cnt_2 for a second divided block.

lba_2 is a head LBA as an access destination within the second divided block. unit_2 indicates the number of an area within the volume V which area corresponds to the second divided block. node_2 is the node number of the node N in charge of the second divided block. io_blk_cnt_2 indicates the number of LBAs in an I/O range within the second divided block. A result of the calculation is as follows.

$${lba}_{—} 2 = {lba}_{—} 1 + {io}_{—} {blk}_{—} {cnt}_{—} 1 = 0 x 8000$$

$${unit}_{—} 2 = {lba}_{—} 2 \text{/} {unit}_{—} size = 0 x 8000 \text{/} 0 x 4000 = 2$$

$${node}_{—} 2 = ( {unit}_{—} 2 + lun ) \% nodeCnt = ( 2 + 2 ) \%4 = 0$$

$$\begin{matrix}{io}_{—} {blk}_{—} {cnt}_{—} 2 = {start}_{—} lba + {io}_{—} {blk}_{—} cnt - {lba}_{—} 2 \\ = 0 x 7000 + 0 x 2000 - 0 x 8000 \\ = 0 x 1000\end{matrix}$$

Therefore, the I/O request for the second divided block is an I/O request to a node N having a node number “0,” the I/O request having, as an I/O range, a range of “0x1000” LBAs from an LBA “0x8000.” It is thus possible to deal with an I/O request straddling a plurality of divided blocks within a volume V.

(Example of Operation of Storage System 200)

Next, referring to FIG. 8, description will be made of an example of operation of the storage system 200 for an I/O request from the host device 201. In the following, a case is assumed in which a receive node N receiving the I/O request from the host device 201 is the node N2. In addition, description will be made by taking as an example a case where a read request for a volume V is received as the I/O request from the host device 201. In addition, the in-charge node N may be described as a “logic in-charge node N.”

FIG. 8 is a sequence diagram illustrating an example of operation of the storage system 200. In FIG. 8, first, the node N2 receives a read request from the host device 201 (step S801). The node N2 next determines a logic in-charge node N for processing the received read request (step S802).

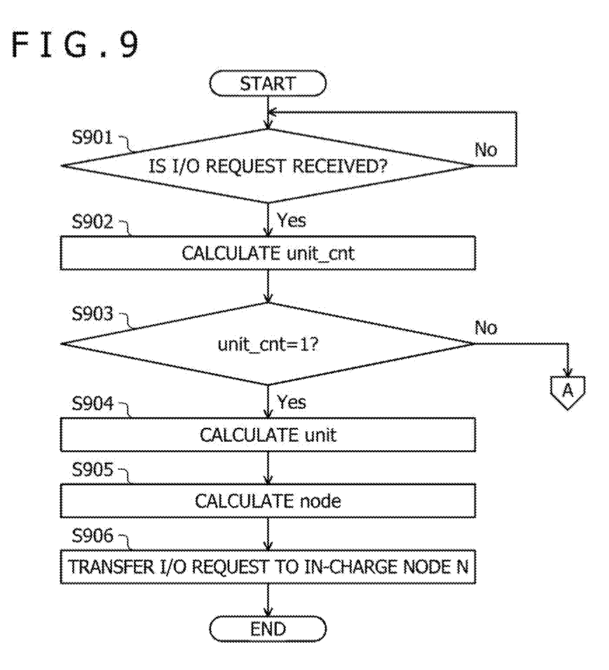

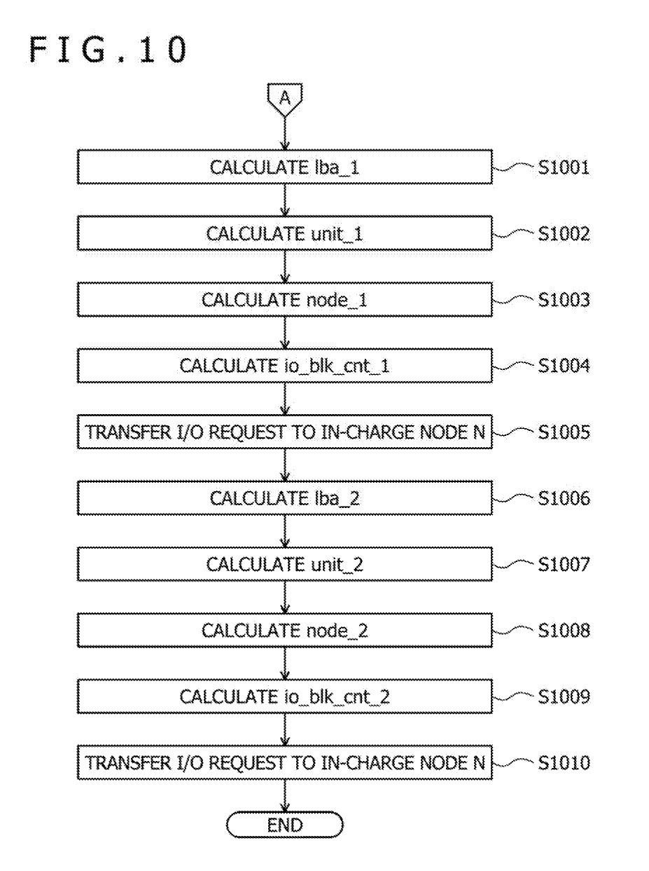

In the following, a case is assumed in which the “node N4” is determined as the logic in-charge node N. Incidentally, a specific processing procedure of determining the logic in-charge node N will be described later with reference to FIG. 9 and FIG. 10.

The node N2 then transfers the received read request from the host device 201 to the determined logic in-charge node N4 (step S803). Next, when the logic in-charge node N4 receives the I/O request from the node N2 (hereinafter the “receive node N2”), the logic in-charge node N4 refers to the logical-physical meta mt, and identifies the physical position of data based on a logical address included in the received I/O request (step S804).

In the following, a case is assumed in which a physical position that the node N3 may directly access is identified as the physical position of the data.

Then, the logic in-charge node N4 notifies the identified physical position to a physical in-charge node N3 (step S805). Next, when the physical in-charge node N3 receives the physical position from the logic in-charge node N4, the physical in-charge node N3 reads the data at the received physical position from a drive d under own control (step S806). The physical in-charge node N3 then expands the read data, and transmits the expanded data to the logic in-charge node N4 (step S807).

Next, when the logic in-charge node N4 receives the data from the physical in-charge node N3, the logic in-charge node N4 transfers the received data to the receive node N2 (step S808). Then, when the receive node N2 receives the data from the logic in-charge node N4, the receive node N2 transfers the received data to the host device 201 (step S809). A series of processing based on the present sequence is thereby ended.

Incidentally, in the storage system 200, for the number n of nodes (n=4), communication between nodes occurs at a rate of (n−1)/n. The storage system 200 may therefore include interfaces capable of communicating at high speed.

(Storage Control Processing Procedure of Node N)

A storage control processing procedure of a node N will next be described with reference to FIG. 9 and FIG. 10. However, in the following, a case is assumed in which an I/O range extends over two divided blocks within a volume V at a maximum.

FIG. 9 and FIG. 10 are flowcharts illustrating an example of the storage control processing procedure of the node N. In the flowchart of FIG. 9, first, the node N determines whether or not an I/O request is received from the host device 201 (step S901). In this case, the node N waits to receive an I/O request (step S901: No).

When the node N then receives an I/O request (step S901: Yes), the node N calculates unit_cnt by using the above-described Equation (4) (step S902). Incidentally, unit_cnt indicates the number of divided blocks straddled by an I/O range. The node N next determines whether or not the calculated unit_cnt is “1” (step S903).

Here, when unit_cnt is “1” (step S903: Yes), the node N calculates unit by using the above-described Equation (3) (step S904). Incidentally, unit indicates the number of an area (divided block) within a volume V to which area the LBA of the volume V corresponds, the LBA being included in the I/O request.

The node N next calculates node by using the above-described Equation (2) (step S905). Incidentally, node is the node number of an in-charge node N. The node N then transfers the I/O request to the in-charge node N identified from the calculated node (step S906). A series of processing based on the present flowchart is thereby ended. However, when node is the node number of the own node, the node N processes the I/O request from the host device 201 in the own node.

In addition, when unit_cnt is “2” in step S903 (step S903: No), the node N proceeds to step S1001 illustrated in FIG. 10.

In the flowchart of FIG. 10, first, the node N calculates lba_1 (step S1001). Incidentally, lba_1 is a head LBA as an access destination within a first divided block. Next, the node N calculates unit_1 (step S1002). Incidentally, unit_1 indicates the number of an area within the volume V to which area the first divided block corresponds.

Next, the node N calculates node_1 (step S1003). Incidentally, node_1 is the node number of a node N in charge of the first divided block. The node N next calculates io_blk_cnt_1 (step S1004). Incidentally, io_blk_cnt_1 indicates the number of LBAs in an I/O range within the first divided block.

The node N then transfers the I/O request having a range of LBAs whose number is io_blk_cnt_1 from lba_1 as the I/O range to the in-charge node N identified from the calculated node_1 (step S1005). However, when node_1 is the node number of the own node, the node N processes the I/O request in the own node.

Next, the node N calculates lba_2 (step S1006). Incidentally, lba_2 is a head LBA as an access destination within a second divided block. The node N next calculates unit_2 (step S1007). Incidentally, unit_2 indicates the number of an area within the volume V to which area the second divided block corresponds.

Next, the node N calculates node_2 (step S1008). Incidentally, node_2 is the node number of a node N in charge of the second divided block. Next, the node N calculates io_blk_cnt_2 (step S1009). Incidentally, io_blk_cnt_2 indicates the number of LBAs in an I/O range within the second divided block.

The node N then transfers the I/O request having a range of LBAs whose number is io_blk_cnt_2 from lba_2 as the I/O range to the in-charge node N identified from the calculated node_2 (step S1010). A series of processing based on the present flowchart is thereby ended. However, when node_2 is the node number of the own node, the node N processes the I/O request in the own node. Thus, a load imposed in I/O processing of each volume V may be distributed appropriately among the nodes N1 to N4.

As described above, the node N according to the embodiment may receive an I/O request from the host device 201, and determine an in-charge node N according to the logical address of a volume V, the logical address being included in the I/O request. For example, the node N may determine the in-charge node N based on the LBA of the volume V, the number of LBAs per divided block size, a volume number, and the number of nodes of the storage system 200 by using the above-described Equations (2) and (3).

It is thereby possible to efficiently determine the in-charge node N for performing load distribution among the nodes N1 to N4 and maintain stable performance of the storage system 200. For example, an in-charge node N may be assigned to each divided block (LBA of a specific size) within the volume V. Therefore, for example, a greater effect of load distribution on random I/O may be expected. In addition, an in-charge node N for a head divided block may be shifted between volumes V. Therefore, even when access concentrates on one divided block in each volume V, for example, a degradation in performance may be suppressed.

In addition, when the determined in-charge node N is the own device, the node N may process the I/O request in the own node. When the determined in-charge node N is another node, the node N may transfer the I/O request to the in-charge node N to make the in-charge node N process the I/O request. Thus, a load imposed in the processing of the I/O request from the host device 201 may be distributed.

In addition, the node N may determine whether or not an I/O range extends over a plurality of divided blocks of a volume V based on the head LBA and the LBA range of the volume V, the head LBA and the LBA range being included in the I/O request, and the number of LBAs per divided block size. Then, when the I/O range extends over a plurality of divided blocks, the node N may divide the I/O range into a plurality of I/O ranges, and determine in-charge nodes N for I/O requests corresponding to the plurality of respective divided I/O ranges. Thus, even in the case of an I/O request having an I/O range straddling a plurality of divided blocks within a volume V, the I/O range may be divided into a plurality of I/O ranges, and each of in-charge nodes N in charge of the respective I/O ranges may be determined.

From the above, according to the storage system 200 in accordance with the embodiment, loads on respective nodes N are distributed substantially equally, and a maximum performance desired in each node N may be reduced. In addition, storage design becomes easy as compared with a case where a user considers, for each business, which node N is in charge of which business. In addition, even when a load increases suddenly, load distribution is performed among all of the nodes N. It is therefore possible to deal with addition of a new business or a change in work load, and provide stable performance while avoiding a hot spot. In addition, performance may be improved linearly without setting changes being made in the storage, volumes, or the like.

Incidentally, the storage control method described in the present embodiment may be implemented by a computer such as a personal computer, a workstation, or the like by executing a program prepared in advance. The present storage control program is recorded on a computer readable recording medium such as a hard disk, a flexible disk, a compact disc (CD)-ROM, a magneto-optical disk (MO), a digital versatile disk (DVD), a universal serial bus (USB) memory, or the like, and is executed by being read from the recording medium by a computer. The present storage control program may also be distributed via a network such as the Internet or the like.

In addition, the node N (storage control device 101) described in the present embodiment may also be implemented by an application specific integrated circuit (IC) (hereinafter referred to simply as an “ASIC”) such as a standard cell, a structured application specific integrated circuit (ASIC), or the like, or a programmable logic device (PLD) such as a field programmable gate array (FPGA) or the like. For example, the node N (storage control device 101) may be manufactured by defining the functions (the receiving unit 501 to the processing unit 504) of the above-described node N by hardware description language (HDL) descriptions, performing logic synthesis of the HDL descriptions, and providing a result of the logic synthesis to an ASIC or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
a memory; and
a processor coupled to the memory and configured to perform a process including:
receiving, from a higher-level device, an input/output request including a logical address specifying a logical block within a volume; and
determining a storage control device for processing the input/output request from among a plurality of storage control devices that may access a storage having a physical storage area assigned to the volume based on the logical address included in the received input/output request, the number of logical blocks per divided block size partitioning the volume, and number of the plurality of storage control devices.

2. The storage control device according to claim 1, wherein in the determining, the storage control device for processing the input/output request is determined based on the logical address, the number of logical blocks, a volume number specifying the volume, and the number of the storage control devices.

3. The storage control device according to claim 2, wherein the logical address is specified by LBA (Logical Block Address), and in the determining,
the storage control device for processing the input/output request is determined by using an equation that derives a device number of the storage control device for processing the input/output request based on the LBA of the volume included in the input/output request, the number of LBA per divided block size, the volume number, and the number of the plurality of storage control devices.

4. The storage control device according to claim 1, the process further including:
processing the input/output request, if the storage control device is determined as the storage control device for processing the input/output request; and
transmitting the input/output request to another storage control device, if the determined storage control device for processing the input/output request is the other storage control device, among the plurality of storage control devices.

5. The storage control device according to claim 1, wherein the logical address is specified by LBA (Logical Block Address), and in the determining,
the storage control device for processing the input/output request is determined by using an equation that derives a device number of the storage control device for processing the input/output request based on the LBA of the volume included in the input/output request, the number of LBA per divided block size, and the number of the plurality of storage control devices.

6. The storage control device according to claim 3, the process further including:
dividing an input/output range into two or more input/output ranges, in case an input/output range extends over a plurality of the divided blocks, which case is determined based on a head LBA of the volume included in the input/output request, a LBA range of the volume included in the input/output request, and the number of LBA per divided block size; and
in the determining, the storage control device for processing the input/output request is determined for each of the input/output requests for the respective input/output ranges.

7. The storage control device according to claim 1, the process further including:
receiving, from another storage control device, the input/output request from the higher-level device; and
notifying a processing result, after processed the input/output request, to the other storage control device.

8. A non-transitory computer-readable storage medium storing a storage control program for causing a computer to perform:
receiving, from a higher-level device, an input/output request including a logical address specifying a logical block within a volume; and
determining a storage control device for processing the input/output request from among a plurality of storage control devices that may access a storage having a physical storage area assigned to the volume based on the logical address included in the received input/output request, the number of logical blocks per divided block size partitioning the volume, and number of the plurality of storage control devices.

9. The storage medium according to claim 8, wherein in the determining, the storage control device for processing the input/output request is determined based on the logical address, the number of logical blocks, a volume number specifying the volume, and the number of the storage control devices.

10. A storage system including a plurality of storage control devices and a storage accessible by the plurality of storage control devices, at least one of the plurality of storage control devices includes:
a memory; and
a processor coupled to the memory and configured to perform a process including:
receiving, from a higher-level device, an input/output request including a logical address specifying a logical block within a volume; and
determining a storage control device for processing the input/output request from among a plurality of storage control devices that may access a storage having a physical storage area assigned to the volume based on the logical address included in the received input/output request, the number of logical blocks per divided block size partitioning the volume, and number of the plurality of storage control devices.

11. The storage system according to claim 10, wherein in the determining, the storage control device for processing the input/output request is determined based on the logical address, the number of logical blocks, a volume number specifying the volume, and the number of the storage control devices.
